(19) United States
(12) Patent Application Publication
(10) Pub. No.: US 2009/0253841 A1
(43) Pub. Date: Oct. 8, 2009

(54) Method for producing chemicals

(75) Inventors: Tomohide Ueyama, Kanagawa (JP); Hideharu Nagasawa, Kanagawa (JP); Yasunori Ichikawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku (JP)

(21) Appl. No.: 11/886,957

(22) PCT Filed: Mar. 22, 2006
(86) PCT No.: PCT/JP2006/306372

§ 371 Date: Sep. 24, 2007

(30) Foreign Application Priority Data
Mar. 23, 2005 (JP) 2005-084562

(51) Int. Cl. C08K 5/23

(52) U.S. Cl. 524/190

(57) ABSTRACT

There is provided a method for producing chemicals using a device which carries out reaction operations or unit operations for fluids flowing through a flow channel, in which the reaction operations or unit operations for the object fluids can be controlled highly accurately, and besides, a functional fluid can be provided with various functions according to the type of the reaction operations or unit operations. The method produces chemicals using a device 10 in which a plurality of object liquids L1, L2 are fed through respective fluid-feeding channels 24, 28 therefor and joined together in a single flow channel 30 to carry out reaction operations or unit operations, the method including forming a functional layer between the object fluids by allowing a functional fluid having a function of controlling the reaction operations or unit operations to flow through the flow channel.

### TECHNICAL FIELD

The present invention relates to a method for producing chemicals, in particular, to a technology for producing chemicals using a device that allows a plurality of fluids to flow through a single flow channel to carry out reaction operations or unit operations.

### BACKGROUND ART

In recent years, technologies for producing chemicals by reacting a plurality of fluid with each other while allowing the fluids to flow through a single flow channel have been in the limelight in areas such as, for example, the chemical industry or the pharmaceutical industry, where pharmaceuticals, reagents and the like are produced. One typical example of such technologies is microchemical devices such as microreactors. Microreactors are devices embodying a technology for continuously producing chemicals as reaction products by reacting a plurality of fluid with each other while allowing the fluids to flow laminarly through a flow channel whose cross-section is very small. Unlike batch methods, which use a stirring tank or the like, this method causes reactions by allowing fluids to continuously flow through a flow channel, which is a minute space, so that reactive molecules in the fluids encounter each other at their interface. Thus, the method provides significantly improved reaction efficiency and makes it possible to produce chemicals as excellently monodisperse minute particles.

Examples of technologies relating to microreactors include those disclosed in Japanese Patent Application Laid-Open Nos. 2002-292274, 2003-164745 and 2003-280126.

Japanese Patent Application Laid-Open No. 2002-292274 discloses a flow type microreaction flow channel which includes a chief flow channel having an equivalent diameter of 1 cm or less and one or more lead-in flow channels which join the chief flow channel and is designed to allow a first reaction fluid, which flows through the chief flow channel, to join and react with a second reaction fluid, which flows through the lead-in flow channels, wherein the discharge opening at the tip of each inserting portion formed in the chief flow channel by extending the one or more lead-in flow channels is kept away from the wall surface which forms the chief flow channel. This technology suppresses the clogging of the chief flow channel, which is a very small flow channel, thereby allowing reactions to be carried out stably.

Japanese Patent Application Laid-Open No. 2003-164745 discloses a technology where between two micro channels through which two different kinds of fluids A, B are allowed to flow, respectively is provided an auxiliary micro channel through which a fluid C, which reacts with neither fluid A nor fluid B, is allowed to flow so that the area in which the fluids A and B come in contact with each other is kept away from the outlet of each micro channel. This technology prevents the deposits produced by reactions from accumulating in the neighborhood of the micro channel outlets, thereby allowing reactions to be carried out stably. Japanese Patent Application Laid-Open No. 2005-46651 discloses a technology where a fluid that does not participate in reactions is put between two fluids that do participate in reactions so as to dilute the two fluids that do participate in reactions with the fluid that does not participate in reactions, thereby preventing the occurrence of coalescence.

When using devices which carry out reaction operations while allowing a plurality of fluids to flow through a single flow channel to produce desired chemicals, what is important is not only preventing the clogging of flow channels caused by deposition or coalescence as mentioned above, but controlling the reaction rate of fluids or the particle size of chemicals, as reaction products, highly accurately. As one of the measures, for example, Japanese Patent Application Laid-Open No. 2002-292274 proposes that the device should be heated by circulating a heating medium so that the fluid flowing through the chief flow channel is heated to a proper reaction temperature. And Japanese Patent Application Laid-Open No. 2003-280126 proposes that a vibration generator should be provided on the periphery of the device so that vibration is transmitted to fluids to increase the molecule movement of the fluids, thereby accelerating reactions.

### DISCLOSURE OF THE INVENTION

However, the technologies disclosed in Japanese Patent Application Laid-Open Nos. 2002-292274 and 2003-280126 are to provide fluids with functions (actions) of heat or vibration from outside of the flow channels, and they give rise to problems of having limitations in controlling reaction operations for the fluids flowing through the flow channels and in the types of functions they can provide the fluids.

These problems occur not only in devices which carry out reaction operations for fluids flowing through flow channels, but in devices which carry out unit operations (e.g. mixing, extraction, separation, heating, cooling, heat exchange, crystallization and absorption) to fluids flowing through flow channels.

The present invention has been made in the light of the circumstances. Accordingly, an object of the present invention is to provide a novel method for producing chemicals using a device which carries out reaction operations or unit operations for fluids flowing through a flow channel, in which the reaction operations or unit operations for object fluids can be controlled highly accurately and a functional fluid can be provided with various functions according to the type of reaction operations or unit operations for object fluids.

To accomplish the object, a first aspect of the present invention provides a method for producing chemicals using a device in which a plurality of object fluids are fed through respective fluid-feeding channel therefor and joined together in a single flow channel to carry out reaction operations or unit operations, the method including a step of allowing a functional fluid having a function of controlling the reaction operations or unit operations to flow through the flow channel to form a functional layer between the object fluids.

According to the first aspect of the present invention, a functional fluid having a function of controlling reaction operations or unit operations is flowed through the flow channel to form a functional layer between object fluids, whereby the object fluids can be directly provided with a function by the functional fluid. This enables the reaction operations or unit operations in the flow channel to be controlled highly accurately, and besides, enables the functional fluid to have various functions according to the type of the reaction operations or unit operations for the object fluids; thus, desired chemicals, which have never been produced, can be produced.

The term “object fluids” herein used means fluids which are subjected to reaction operations or unit operations. The number of the object fluids may be 2 or more, as long as a functional layer of a functional fluid is formed between them. The functional fluid represents a fluid that has the function of controlling the reaction operations or unit operations for the object fluids, but does not change chemicals produced themselves.

The term “reaction” used herein includes reaction involving mixing. Types of reactions are: for example, ionic reaction, redox reaction, thermal reaction, catalytic reaction, free-radical reaction and polymerization reaction of inorganic or organic substances. The term “fluid” herein used includes liquids, gases, solid/liquid mixtures in which metal particles or the like are dispersed in liquids, solid/gas mixtures in which metal particles or the like are dispersed in gases, and gas/liquid mixtures in which gases are not dissolved, but dispersed in liquids.

To accomplish the object, a second aspect of the present invention provides a method for producing chemicals using a device in which three or more fluids are fed through respective fluid-feeding channels therefor and joined together in a single flow channel to carry out reaction operations or unit operations, the method including a step of providing, in the flow channel, a plurality of fluid-joining position in which the three or more fluids are joined together gradually and allowing the three or more fluids to flow therethrough so that the time-lag between the fluid-joining at one joining position and the fluid-joining at the next joining position is between 0.001 second and 60 seconds.

According to the second aspect of the present invention, a plurality of fluid-joining positions are provided in the flow channel in which three or more fluids are joined together gradually, whereby the first two fluids are joined together at the first fluid-joining position, the third fluid joins the first two fluids at the second fluid-joining position, and the rest of the fluids join one after another in the same manner. This enables the fluids to be superimposed in the flow channel with their flows kept stable, whereby reaction operations or unit operations can be carried out highly accurately. In this case, if the time-lag between the fluids joining at one position and the fluids joining at the next position is too large, when, for example, intending to form a functional layer of one fluid between other two fluids, the one fluid having a function is completely diffused with other fluids and cannot function any more. Accordingly, the time-lag needs to be 60 seconds or shorter, preferably 30 sec or shorter and particularly preferably 10 seconds or shorter. The time-lag of “0.001 sec” represents that none of the positions at which fluids join each other can be the same, but they are slightly different.

A third aspect of the present invention provides the method for producing chemicals according to the second aspect of the present invention, wherein the method includes a step of forming a functional layer of a functional fluid between object fluids, wherein the three or more fluids consist of the object fluids carrying out the reaction operations or unit operations, and the functional fluid having a function of controlling the reaction operations or unit operations.

According to the third aspect of the present invention, the three or more fluids consist of two or more object fluids and a functional fluid having a function of controlling the reaction operations or unit operations, and a functional layer of the functional fluid is formed between the object fluids whereby the functional fluid are allowed to provide the object fluids with a function. In cases where three or more fluids consists of object fluids and a functional fluid, as described above, if the fluids are flowed so that the time-lag between the fluids joining at one position and the fluids joining at the next position is between 0.001 second and 60 seconds, the fluids can be superimposed in the flow channel with their flows kept stable, whereby the functions of the functional fluid are allowed to affect the object fluids highly accurately.

A fourth aspect of the present invention provides the method for producing chemicals according to any one of the first to third aspects, wherein the device is a microchemical device in which the flow channel has an equivalent diameter of 1 mm or less.

The term “equivalent diameter” herein used represents the diameter obtained when converting the cross-section of the flow channel into a circle. Particularly preferable equivalent diameter of the flow channel is 500 μm or less.

A fifth aspect of the present invention provides the method for producing chemicals according to any one of the first to fourth aspects, wherein the fluids flow laminarly in the flow channel.

The present invention is applicable even in cases where the flow channel has a large equivalent diameter and fluids flow in the turbulent-flow through the flow channel; however, it is more effective when using a microchemical device where fluids (object fluids and a functional fluid) flow laminarly. The reason is that, when fluids flow laminarly, reaction operations or unit operations are allowed to progress by the diffusion movement of the fluids in the direction normal to the interfaces thereof, and thus the functions (e.g. temperature diffusion) of the functional fluid can provide the object fluids with a function highly accurately utilizing the diffusion movement.

A sixth aspect of the present invention provides the method for producing chemicals according to any one of the first, third, fourth and fifth aspects, wherein the functional fluid in the reaction operations has a function of controlling the rate of the reaction between the object fluids.

For example, if the rate of the reaction between the object fluids, is decreased by the functional fluid, the reaction is not activated immediately at the position where the object fluids are joined together, whereby the deposition of the reaction product at the joining position can be suppressed and the clogging at the outlet of the fluid-feeding channels can be prevented. Furthermore, if the rate of the reaction between the object fluids is decreased by the functional fluid, an explosive reaction can be controlled highly accurately, and therefore, such a reaction can be carried out safely. Conversely, if the rate of the reaction between the object fluids is increased by the functional fluid, the reaction can be completed in a short time. Thus, controlling the rate of the reaction between the object fluids highly accurately makes it possible to design the reaction elaborately according to the characteristics of the object fluids or the reaction time suitable for the same.

A seventh aspect of the present invention provides the method for producing chemicals according to the sixth aspect, wherein the rate of the reaction is controlled by allowing at least one of the temperature, viscosity, pH, concentration and density of the functional fluid to differ from the temperature, viscosity, pH, concentration or density of the object fluids.

The seventh aspect of the present invention is one example of the embodiments of the present invention where the functional fluid controls the rate of the reaction between the object fluids, for example, by utilizing temperature diffusion caused by the temperature difference between the functional fluid and the object fluids. For example, if the temperature of the functional fluid is made lower than that of the object fluids, the rate of the reaction between the object fluids can be decreased by the diffusion of the cold from the functional fluid. Conversely, if the temperature of the functional fluid is made higher than that of the object fluids, the rate of the reaction between the object fluids can be increased by the diffusion of the heat from the functional fluid. Likewise, the rate of the reaction can be controlled by utilizing the difference in viscosity, pH, concentration or density between the functional fluid and the object fluids.

An eighth aspect of the present invention provides the method for producing chemicals according to any one of the first, third, fourth and fifth aspects, wherein the functional fluid in the reaction operations has a function of controlling the particle size of the chemicals as products of the reaction between the object fluids.

For example, when intending to produce fine and excellently monodisperse chemicals by the reaction between the object fluids, if additives such as polymer, surfactant and pH adjustor are added to the functional fluid, the reaction can be controlled to prevent unnecessary coalescence and provide chemicals with a fine particle size. Further, when intending to produce water-insoluble chemicals such as pigments, not only additives such as polymer, surfactant and pH adjustor, but rosin or a synergist can also be added to the functional fluid.

A ninth aspect of the present invention provides the method for producing chemicals according to any one of the first, third, fourth and fifth aspects, wherein the functional fluid in the unit operations has a function of liquid membrane extraction.

For example, if a functional fluid which does not mix with the object fluids, but has the function of selectively allowing a specific component to migrate from one of the object fluids to another is used to form a functional layer, the specific component can be extracted.

A tenth aspect of the present invention provides the method for producing chemicals according to any one of the first, fourth, fifth, sixth, seventh, eighth and ninth aspects, wherein the a plurality of object fluids are gradually joined together via the functional layer and with a time-lag between one fluid-joining step and the next fluid-joining step.

Joining a plurality of fluids together gradually via the functional layer and with a time-lag between one fluid-joining step and the next fluid-joining step makes it possible to form a stable functional layer and stabilize the flow of the object fluids. This enables the functions of the functional fluid to provide the object fluids with a function highly accurately.

An eleventh aspect of the present invention provides the method for producing chemicals according to the tenth aspect, wherein the time-lag between one fluid-joining step and the next fluid-joining step is between 0.001 second and 60 seconds.

If the time-lag is longer than 60 sec, though it depends on the velocity of the liquids flowing through the flow channel, the superimposition of the fluids is not stabilized, and besides, the object fluids might join each other after the functional fluid has lost its functions. This makes it impossible to achieve the primary objective of the functional fluid use, or to control the reaction operations or unit operations for the object fluids, even if the clogging at the outlet of the fluid-feeding channels can be prevented. The time-lag is more preferably between 0.001 second and 30 seconds and particularly preferably between 0.001 second and 10 seconds.

A twelfth aspect of the present invention provides the method for producing chemicals according to any one of the first, third, fourth, fifth, sixth, seventh, eighth, ninth, tenth and eleventh aspects, wherein the functional layer has a thickness of between 1 μm and 1000 μm.

If the thickness is as small as less than 1 μm, a stable functional layer cannot be formed, whereas if the thickness is as large as more than 1000 μm, excellently monodisperse minute chemicals are hard to obtain. Preferably the thickness of the functional layer is between 1 μm and 500 μm and more preferably between 1 μm and 100 μm.

A thirteenth aspect of the present invention provides the method for producing chemicals according to any one of the first to twelfth aspects, wherein the chemicals are pigments.

The present invention is applicable to the production of chemicals in general in which flow channels are utilized; however, it is particularly effective in the production of excellently monodisperse minute pigments.

As described so far, according to the method for producing chemicals of the present invention, in devices which carry out reaction operations or unit operations for fluids flowing through their flow channels, the reaction operations or unit operations can be controlled highly accurately, and besides, a functional fluid can be provided with various functions according to the type of reaction operations or unit operations for the object fluids. Accordingly, desired chemicals, which have not been conventionally produced, can be produced.

### BRIEF DESCRIPTION OF THE DRAWINGS

FIG. 1 is a block diagram illustrating the entire structure of a production device forming a laminar flow;

FIGS. 2A and 2B are horizontal sectional view and vertical sectional view, respectively, of the production device forming a laminar flow of FIG. 1;

FIG. 3 is a partial sectional view of the production device with laminar flow configuration of FIG. 1, where fluids are allowed to join each other gradually at different joining positions;

FIG. 4 is a block diagram illustrating the entire structure of a production device forming an annular flow to which the method for producing chemicals of the present invention is applied;

FIG. 5 is an exploded perspective view of the production device forming an annular flow;

FIG. 6 is an exploded perspective view of the production device forming an annular flow;

FIG. 7 is a cross-sectional view of the production device forming an annular flow;

FIG. 8 is a partial perspective view showing the flow-in side of the plate of the production device forming an annular flow;

FIG. 9 is a partial perspective view showing the flow-out side of the plate of the production device forming an annular flow;

FIG. 10 is a partial front view showing the flow-out side of the plate of the production device forming an annular flow;

FIG. 11 is a partial sectional view of the production device forming an annular flow, where fluids are allowed to join each other gradually at different joining positions;

FIG. 12 is an illustration of a variation of the production device forming an annular flow;

FIG. 13 is an illustration of a variation of the production device forming an annular flow, where fluids are joined together gradually at different joining positions;

FIG. 14 is another illustration of a variation of the production device forming an annular flow, where fluids are joined together gradually at different joining positions;

FIG. 15 is graphs illustrating an example of the present invention; and

FIG. 16 is a curve illustrating an example of the present invention.

### DESCRIPTION OF SYMBOLS

10 . . . a production device with laminar flow configuration, 12 . . . the main body of the device 10, 14 . . . feeding pipes for feeding object liquids, 16 . . . feeding device for feeding object liquids, 18 . . . a feeding pipe for feeding a functional liquid, 20 . . . feeding device for feeding a functional liquid, 21, 22 . . . partition plates, 24, 28 . . . feeding channels for feeding object liquids, 26 . . . a feeding channel for feeding a functional liquid, 30 . . . a flow channel where reaction operations or unit operations are carried out, 100 . . . a production device forming an annular flow, 111 . . . the main body of the device 100, 111C . . . penetration for outer layer, 112 . . . a plate, 112A . . . a plate penetration, 112B . . . slit cylindrical penetration, 112C . . . thick, short cylindrical concavity, 113B . . . a radial flow channel, 113C . . . a radial flow channel, 114 . . . a lid member, 114A . . . a lid member penetration, 115C . . . outer layer flow channel, 116 . . . a main body member, 124A, 124B, 124C . . . feeding channels, 128 . . . a flow channel where reaction operations or unit operations are carried out, 140 . . . internal partition wall portion, 141 . . . flow channel wall forming portion, 146, 148 . . . engaging members, 147, 149 . . . fitting holes, 152 . . . bolt, 156, 158 . . . insert holes, L1 . . . object liquid, L2 . . . object liquid, LK . . . a functional liquid, LM . . . a liquid reaction product

### BEST MODE FOR CARRYING OUT THE INVENTION

In the following, preferred embodiments of the method for producing chemicals in accordance with the present invention will be described in details with reference to the accompanying drawings. The embodiments will be described through examples where two liquids L1, L2 are used as fluids to be subjected to reaction operations or unit operations in the present invention and a functional layer of a functional liquid LK is formed between the two liquids L1 and L2.

### First Embodiment

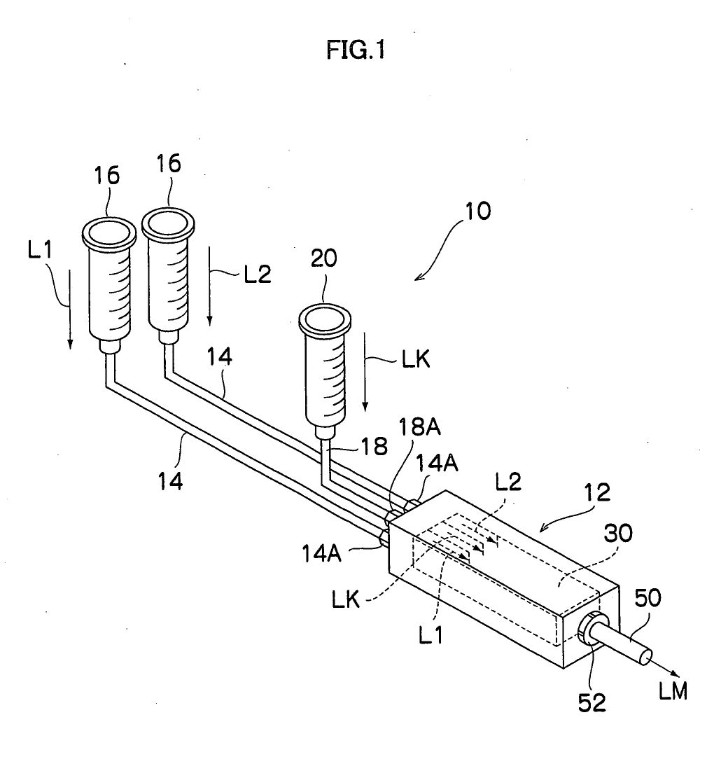

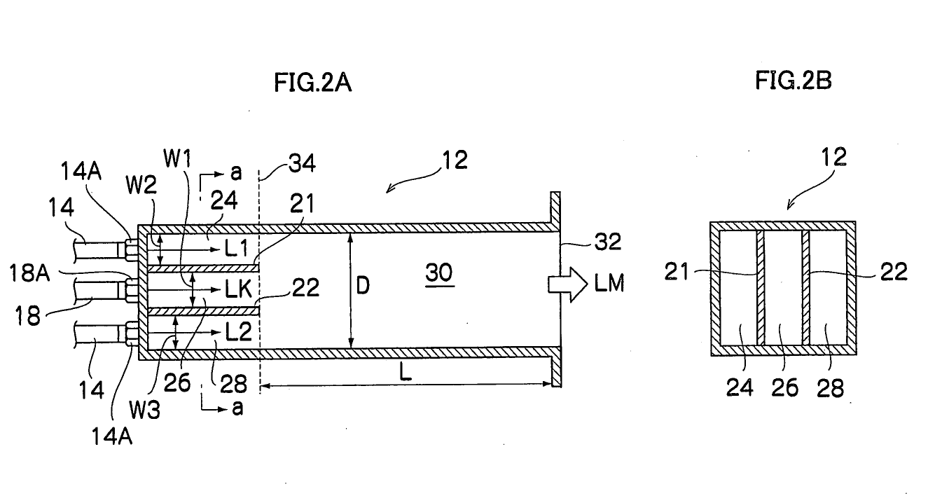

FIG. 1 is a conceptual diagram illustrating the entire structure of a production device 10 to which the method for producing chemicals in accordance with the present invention is applied. The device is so configured that three liquids L1, L2 and LK create laminar flows. FIG. 2A is a horizontal sectional view of the main body 12 of the device 10 and FIG. 2B a vertical sectional view of the main body 12 of FIG. 2A taken along the line a-a.

As shown in FIG. 1, the production device 10 with the laminar-flow configuration consists mainly of: the main body 12; liquid feeding device 16, 16 which feed the object liquids L1, L2 to the main body 12 through feeding pipes 14, 14; and functional-liquid feeding device 20 which feeds the functional liquid LK having a function of controlling the reaction operations or unit operations to the main body 12 through a feeding pipe 18. The feeding pipes 14, 18 are removably connected to the main body 12 via connectors 14A, 18A.

As shown in FIGS. 2A and 2B, the main body 12 is formed in a square cylinder with its inlet-side portion, to which the feeding pipes 14, 18 are to be connected, divided in three with two partition plates 21, 22 provided longitudinally. Thus, feeding channels 24, 28 for feeding the object liquids L1, L2 and a feeding channel 26 for feeding the functional liquid LK are formed in the upstream of the main body 12. These three feeding channels 24, 26, 28 join a flow channel 30 where reaction operations or unit operations are carried out to the liquids L1, L2. Thus, the feeding pipes 14, 18 are connected to the feeding channels 24, 26, 28, respectively, so that they are in communication with each other. As a result, the liquids L1, L2 and the functional liquid LK having flowed through the feeding channels 24, 26, 28, respectively, and having joined together in the flow channel 30 create a three-layer laminar-flow structure with a functional layer of the functional liquid LK formed between the liquids L1 and L2.

Examples of preferable functions of the functional liquid LM in the reaction operations include, but not limited to, functions of: controlling the rate of the reaction between the object liquids L1 and L2; and controlling the particle size of the chemicals as reaction products of the object liquids L1 and L2. Examples of preferable functions of the functional liquid LK in the unit operations include, but not limited to, a function of liquid membrane extraction. The functional liquid LK may have any functions, as long as the functions make it possible to control the reaction operations or unit operations of the object liquids L1, L2, and never change the chemicals to be produced themselves.

For example, the rate of the reaction may be controlled by allowing at least one of the temperature, viscosity, pH, concentration and density of the functional liquid LK to differ from that (those) of the object liquids L1, L2 when allowing the liquid to flow through the flow channel 30. Alternatively, a liquid having a function of controlling the crystal shape or crystal form may be used as the functional liquid LK. As an example, the XRD analyses of the crystal structure of pigment crystals have shown that there are three crystal forms: α, β, and γ. When intending to produce a pigment by the reaction between the object liquids L1, L2, if a liquid capable of affecting the crystal form of a pigment is used as the functional liquid LK, it is possible to control the crystal form of the pigment produced, whereby a pigment of any one of the α, β and α crystal forms can be preferentially produced. Further, if a liquid capable of affecting the crystal shape of a pigment is used as the functional liquid LK, it is possible to control the crystal shape of the pigment produced, whereby a pigment having any one of the spherical, needle-like and flat plate-like shapes can be preferentially produced.

At the end position of the flow channel 30 is formed a discharge opening 32 for discharging a liquid reaction product LM containing the chemical produced by the reaction. To the discharge opening 32 a discharge pipe 50 is removably connected via a connector 52 so that the discharge pipe 50 is in communication with the discharge opening 32 (refer to FIG. 1).

Preferably, the flow channel 30 that creates a three-layer laminar-flow structure is a minute flow channel in the form of a microchannel which has an equivalent diameter of 1 mm (1000 μm) or less, preferably 500 μm or less. This is because the present invention, though it is applicable even to cases where the flow channel 30 has a large equivalent diameter and liquids flow in the turbulent-flow through the flow channel, is more effective where the equivalent diameter of the flow channel 30 is 1 mm or less and object liquids and a functional liquid flow laminarly through the flow channel. In other words, preferably the equivalent diameter of the flow channel 30 is such that it allows the Reynolds number (Re) to be 200 or less. The reason is that in the laminar-flow, reaction operations or unit operations are allowed to progress by the diffusion movement of the liquids in the direction normal to the interfaces thereof, and thus the functional liquid LK can provide the object liquids L1, L2 with functions highly accurately when utilizing the diffusion movement. Preferably the thickness of the functional layer formed by the functional fluid LK in the flow channel 30 is between 1 μm and 100 μm, and preferably the width W1 of the feeding channel 26 for feeding the functional liquid LK is formed so that the functional layer has a thickness in the range. The length L of the flow channel 26 (refer to FIGS. 2A and 2B) is set so that it is large enough to complete reaction operations or unit operations, though it depends on the type of reaction operations or unit operations. The widths W2, W3 of the feeding channels for feeding the object liquids L1, L2 should be appropriately set according to the equivalent diameter of the flow channel 30 or the amount of the object liquids L1, L2 and the functional liquid LK fed to the flow channel 128.

In FIGS. 2A and 2B, feeding channels 24, 26, 28 join the flow channel 30 at the same position 34. However, it is preferable that the position A where the object liquid L1 joins the functional liquid LK and the position B where the object liquid L2 join the liquids L1, LK are different. In other words, it is preferable that there is time-lag between the joining of the liquid L1 and the functional liquid LK and the joining of the liquid L2 and the liquids L1, LK. Owing to such a step-by-step joining, the liquids L1, L2, LK can be superimposed, in the flow channel 30, with their flows kept stable, whereby a stable functional layer can be formed between the liquids L1 and L2 while keeping the flows of the liquids L1, L2 stable. In addition, the functions of the functional liquid LK can affect the object liquids L1, L2 highly accurately. The time-lag t between the joining of liquids L1 and LK at position A and the joining of liquids L2 and L1, LK at position B is preferably between 0.001 sec and 60 sec. If the time-lag is longer than 60 sec, though it depends on the velocity of the liquids flowing through the flow channel 30, the formation of the functional layer does not stabilize, and besides, the object liquid L1 and the object liquid L2 might join each other after the functional liquid LK has lost its functions. This makes it impossible to achieve the primary objective of the functional liquid LK use, or to control the reaction operations or unit operations of the object liquids L1 and L2. The time-lag is more preferably between 0.001 sec and 30 sec and particularly preferably between 0.001 sec and 10 sec.

To produce such a main body 12, which has a minute flow channel 30 of the order of micron, micro machining technologies are used. Examples of micro machining technologies used include:

(1) LIGA technology as a combination of X-ray lithography and electro-plating;

(2) high aspect ratio photolithography using EPON SU8;

(3) mechanical micro-cutting (e.g. micro-drilling where a drill with a diameter of the order of micron is rotated at a high speed);

(4) high aspect ratio machining of silicon by Deep RIE;

(5) hot embossing;

(6) optical lithography;

(7) laser machining; and

(8) ion beam technique.

As materials for producing the main body 12, any materials such as metals, glass, ceramics, plastic, silicon and Teflon can be used suitably according to the requirements such as heat resistance, pressure resistance, solvent resistance or easy processing. In the production of the main body 12, the fabrication of the feeding channels 24, 26, 28 and the flow channel 30 is, of course, important, but on the other hand, the bonding technology used for bonding a lid for the feeding channels 24, 26, 28 and the flow channel 30 is also important. As a method for bonding a lid to the main body, a precise method is desirable which is not accompanied by breakage of the feeding channels 24, 26, 28 and the flow channel 30 due to the deterioration or deformation of the material caused by high temperature heating, but allows the channels to keep their dimensional accuracy. Considering the materials used for producing the main body, it is preferable to select solid phase bonding (e.g. pressure bonding or diffusion bonding) or liquid phase bonding (e.g. welding, eutectic bonding, solder bonding or adhesion). Examples of such methods include: silicon direct bonding, which is a method for bonding silicon and silicon together employed when silicon is used as the material for the main body; fusing welding for bonding glass and glass; anodic bonding for bonding silicon and glass; and diffusion bonding for bonding metal and metal. Bonding of ceramics requires a bonding technology other than mechanical seal technology, which is used for bonding metals. One example of bonding methods used for bonding ceramics is a method where a bonding material, glass solder, is printed on alumina to 80 μm by screen printing and the printed alumina is treated at 440 to 500° C. without applying pressure. Novel bonding technologies, which are still in the laboratory stage, include: for example, surface activating bonding; direct bonding using hydrogen bonding; and bonding using an HF (hydrogen fluoride) aqueous solution.

As liquid feeding device 16 for feeding object liquids and liquid feeding device 20 for feeding a functional liquid, continuous-flow-system type of syringe pumps having a function of controlling the feeding pressure for feeding the object liquids L1, L2 or feeding the functional liquid LK can be suitably used in the production device 10 of the present invention. In the production device which includes the minute flow channel 30, a fluid control technology for introducing the object liquids L1, L2 or the functional liquid LK into the flow channel 30 is required. Since the behavior of liquids in the minute flow channel 30 of the order of micron is different in character from that in macro-scale flow channels, a fluid control technology suitable for the micro-scale flow channel must be applied. According to continuous flow system, the inside of the main body 12 and the inside of all the channels extending to the main body 12 are filled with liquids and all the liquid are driven by the syringe pumps 16, 20 prepared outside the main body, and the feeding pressure for feeding the object liquids L1, L2 to the flow channel 30, the flow rate of the object liquids L1, L2, the feeding pressure for feeding the functional liquid LK to the flow channel 30, and flow rate of the functional liquid LK can be arbitrarily controlled. Continuous-flow-system type of pumps include continuous pumps wherein pulsations are controlled to such a degree that they do not affect the flows of liquids.

According to a production device 10 constructed as described above, a functional layer is formed between the object liquids L1 and L2 by allowing the functional liquid LK having a function of controlling the reaction operations or unit operations to flow through the flow channel 30, whereby the functional liquid LK can directly affect the object liquids L1, L2. Thus, the reaction operations or unit operations for the object fluids L1, L2 in the flow channel 30 can be controlled highly accurately, and besides, the object liquids L1, L2 can be provided with various functions according to the type of the reaction operations or unit operations for the object liquids L1, L2, whereby desired chemicals, which have never been produced, can be produced.

In one embodiment of the method for producing chemicals in accordance with the present invention, pigment particles are produced using: a solution of dimethyl sulfoxide (DMSO), a polymer, an alkaline agent and a pigment, as the object liquid L1; a solution of a surfactant in water, as the object liquid L2; and dimethyl sulfoxide (DMSO), as the functional liquid, in such a manner as to form a functional layer of the functional liquid LK between the object liquids L1 and L2 in the flow channel 30 and react the object liquids L1 and L2 in such a state. In this reaction, the time when the object liquids L1 and L2 encounter each other can be adjusted utilizing the functional layer of the functional liquid LK provided between the object liquids L1 and L2, whereby excellently monodisperse fine pigment particles can be produced, and at the same time, the clogging can be prevented from occurring in the neighborhood of the inlets of the feeding channels 24, 26 and 28.

In another embodiment of the method for producing chemicals in accordance with the present invention, pigment particles are produced using: a solution of dimethyl sulfoxide (DMSO), an alkaline agent and a pigment, as the object liquid L1: a solution of water and a surfactant, as the object liquid L2; and a solution of a polymer in dimethyl sulfoxide (DMSO), as the functional liquid, in such a manner as to form a functional layer of the functional liquid LK between the object liquids L1 and L2 in the flow channel 30 and react the object liquids L1 and L2 in such a state. In this reaction, the coalescence of pigment particles produced by the reaction between the object liquids L1 and L2 can be suppressed by utilizing the functional layer of the functional liquid LK which contains a polymer, whereby excellently monodisperse finer pigment particles can be produced.

In another embodiment of the method for producing chemicals in accordance with the present invention, extraction, as a unit operation, is performed using: a solution of toluene and heptane, as the object liquid L1; isooctane, as the object liquid L2; a solution of water and a surfactant, as the functional liquid LK, in such a manner as to form a functional layer of the functional liquid LK between the object liquids L1 and L2. In this unit operation, the object liquids L1 and L2 are mixed with each other, and toluene in the object liquid L1 is extracted to the isooctane in the object liquid L2 owing to the functional layer, which has a liquid membrane extraction function, provided between the object liquids L1 and L2. Thus, if the object liquid L2 with toluene and the object liquid 1 are separated and recovered, a fixed amount of toluene can be recovered stably from the object liquid L1. In the device 10 forming a laminar flow, as shown in FIGS. 1 to 3, only one discharge pipe is provided. However, it is a prerequisite that when such liquid membrane extraction is performed, separation is to be done at the outlet of the device; and thus, it is necessary to provide two discharge pipes.

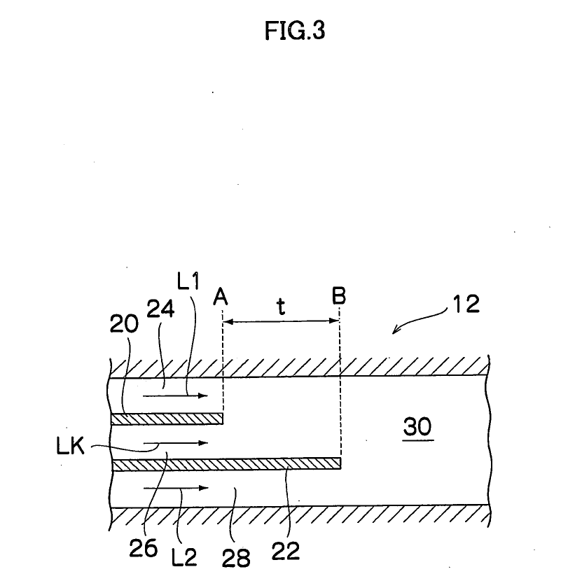

As shown in FIG. 3, if the object liquids L1, L2 and the functional liquid LK are allowed to join each other gradually, the flows of the liquids in the flow channel 30 are stabilized, whereby reaction operations or unit operations can be carried out highly accurately.

### Second Embodiment

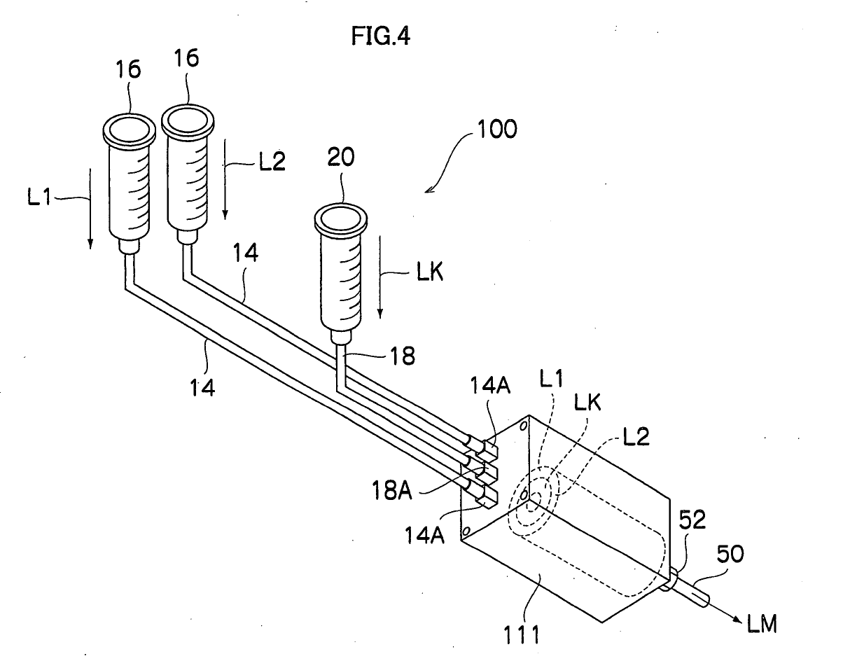

FIG. 4 is a conceptual diagram illustrating the entire structure of a production device 100 to which the method for producing chemicals in accordance with the present invention is applied. The device is so configured that three liquids (object liquids L1, L2 and a functional liquid LK) create flows annularly.

As shown in FIG. 4, the chemical production device 100 consists mainly of: a main body 111; liquid feeding device 16, 16 which feed the liquids L1, L2, as object liquid, to the main body 111 through feeding pipes 14, 14; and functional-liquid feeding device 20 which feeds the functional liquid LK having a function of controlling the reaction operations or unit operations to the main body 111 through a feeding pipe 18.

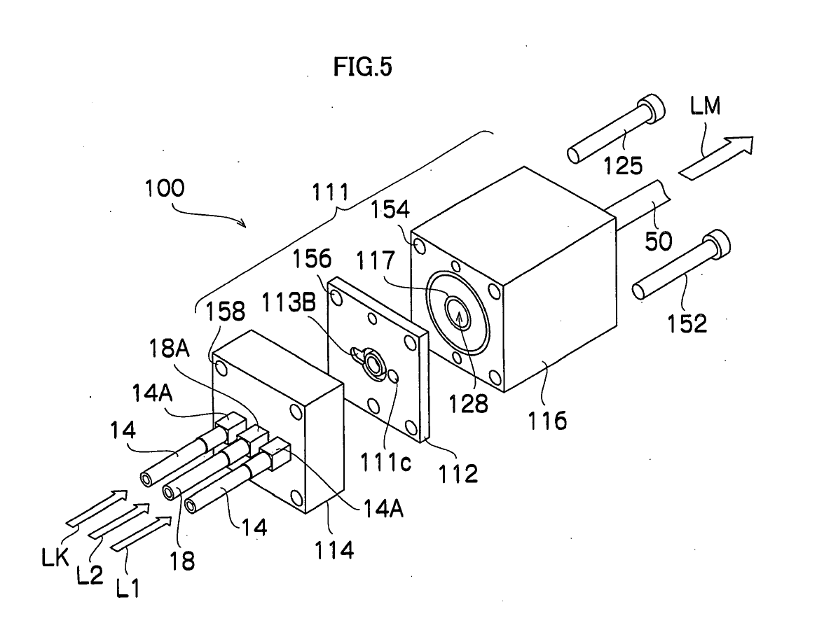

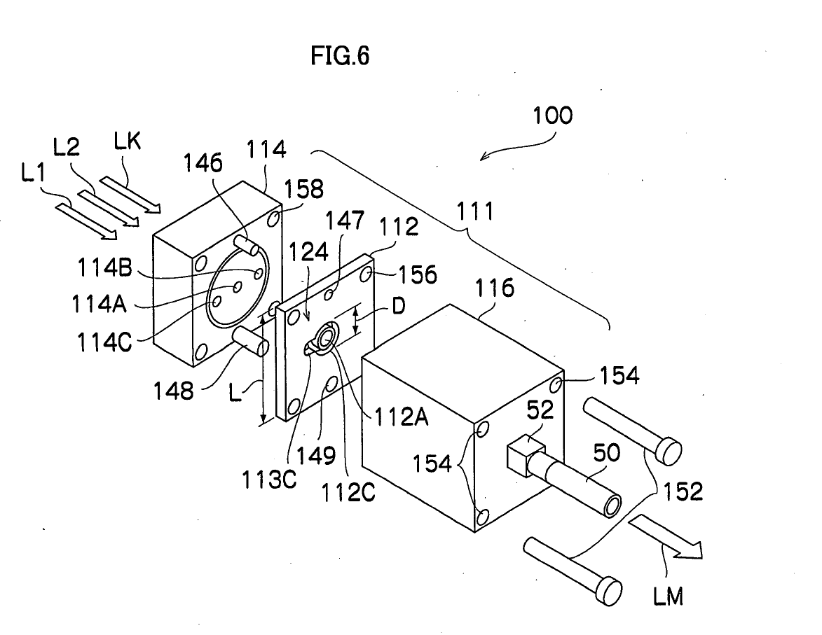

The main body 111 consists of: a plate 112, and a lid member 114 and a main body member 116 which are arranged in the upstream and in the downstream of the plate 112, respectively, so as to hold the plate 112 between them, as shown in FIGS. 5 and 6.

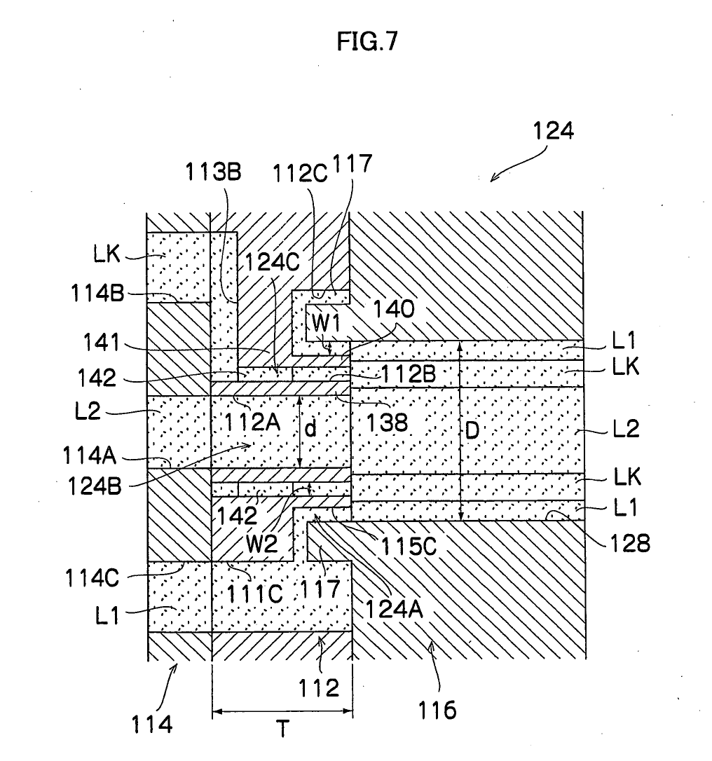

In the upstream of the lid member 114, three feeding pipes 14, 14, 18 for feeding the object liquids L1 and L2 and the functional liquid LK to the main body 111 are removably connected to the main body 12 via connectors 14A, 18A. And in the lid member 114, lid member penetrations 114A, 114B and 114C are formed which the liquids L1, L2 and LK from the feeding pipes 14, 14 and 18 flow in, respectively, as shown in FIG. 7.

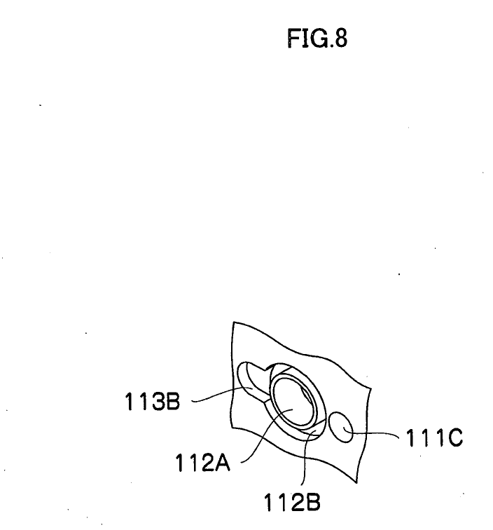

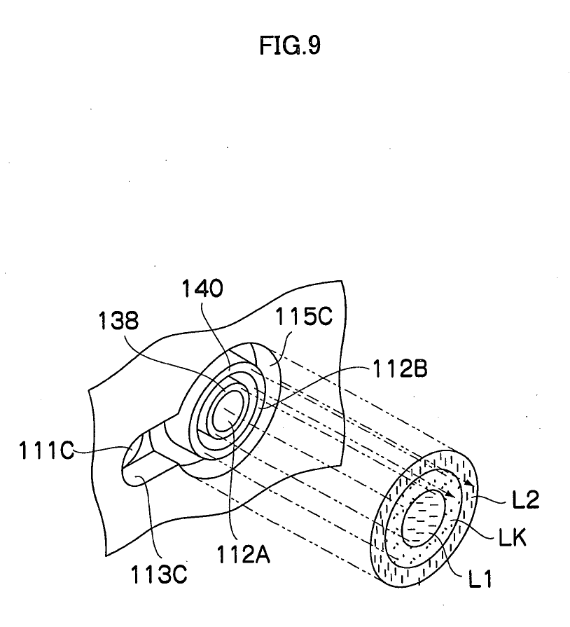

In the plate 112, a feeding channel 124 where the liquids L1, L2 and LK fed from the feeding pipes 14, 18, respectively, are allowed to create flows annularly in the flow channel 128 (refer to FIG. 7). At the center of the plate 112, a plate penetration 112A which is in communication with the lid member penetration 114A is formed, as shown in FIGS. 7 to 10. The lid member penetration 114A and the plate penetration 112A are formed so that they are the same in diameter and kept in the same level. In the plate 112, also formed are a slit cylindrical penetration 112B which is in the slit like form and surrounds the plate penetration 112A and a radial flow channel 113B which is in communication with both the slit cylindrical penetration 112B and the lid member penetration 114B. In the plate 112, also formed are a thick, short cylindrical concavity 112C which surrounds the slit cylindrical penetration 112B, an outer layer penetration 111C which is in communication with the lid member penetration 114C and a radial flow channel 113C which is in communication with the outer layer penetration 111C and the thick, short cylindrical concavity 112C (refer to FIGS. 6 and 9). The radial flow channel 113C is formed almost opposite to the radial flow channel 113B. The plate penetration 112A and the slit cylindrical penetration 112B are partitioned with an internal partition wall portion 138 in the form of a thin, short cylinder, and the slit cylindrical penetration 112B and the thick, short cylindrical concavity 112C are partitioned with an intermediate partition wall portion 140 in the form of a thin, short cylinder. The plate 112 has a flow channel wall forming portion 141 which forms the bottom portion of the thick, short cylindrical concavity 112C and the flow channel wall on the periphery side of the slit cylindrical penetration 112B, and the intermediate partition wall portion 140 is extended from the innermost portion of the flow channel wall forming portion 141 in the direction that the fluids flow out.

In the main body member 116, a single flow channel 128 is formed where the three liquids L1, L2 and LK discharged from the feeding channel 124 are allowed to join each other and reaction operations or unit operations are carried out. And to the main body 116, a discharge pipe 50, which is in communication with the end portion of the flow channel 128, is removably connected via a connector 52. In the main body member 116, the flow channel 128 is formed, as shown in FIG. 7, and the liquids L1, L2 and LK discharged from the thick, short cylindrical concavity 112C, the slit cylindrical penetration 112B and the plate penetration 112A, respectively, join in the flow channel 128, where reaction operations or unit operations are carried out. In the upstream of the main body 116, a ring-like protrusion 117 is formed which is inserted in the thick, short cylindrical concavity 112C at the time of assembling the production device 100 and forms a slit ring-like outer layer flow channel 115C between the concavity 112C and the intermediate partition wall portion 140.

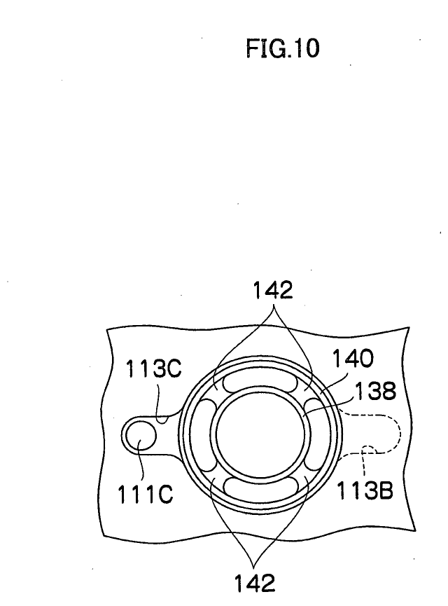

As shown in FIG. 10, in the slit cylindrical penetration 112B, a plurality of rib 142 is provided along the direction that fluids flow out in such a manner that they are connected to the internal partition wall portion 138 and the flow channel wall forming portion 141. These ribs 142 are arranged at almost regular intervals in such a manner that they are kept away from the spaces where the radial flow channels 113B and 113C are formed. In the neighborhood of the outlet of the slit cylindrical penetration 112B, no ribs are provided so that fluids are allowed to flow out annularly.

The annular feeding channel 124 for feeding the three liquids L1, L2 and LK is formed with the outer layer flow channel 115C, the slit cylindrical penetration 112B and the plate penetration 112A by the construction described so far. In other words, the outer layer flow channel 115C forms the annular feeding channel 124A for the object liquid L1, the plate penetration 112A forms the annular feeding channel 124B for the object liquid L2, and the slit cylindrical penetration 112B forms the annular feeding channel 124C for the functional liquid LK. The feeding channels 124A, 124C for the object liquids L1 and L2 are exchangeable, but the functional liquid LK must be fed through the feeding channel 124B. The three-layer annular structure where a functional layer of the functional liquid LK is formed between the layers of the object liquids L1 and L2, as shown in FIG. 9, can be formed by setting the feeding channels 124A to 124C in the manner and allowing the functional liquid LK having a function of controlling reaction operations or unit operations to flow through the flow channel 128.

As shown in FIG. 6, in the inside of the lid member 114 are provided two engaging rod portions 146, 148 which extend from the upper mid portion and the lower mid portion of the lid member 114, while in the plate 112 are formed two fitting holes 147, 149 through which the engaging rod portions 146, 148 are inserted, respectively. The lid member 114 and the plate 112 are positioned to each other by inserting the engaging rod portions 146, 148 through the fitting holes 147, 149. The engaging rod portions 146, 148 are formed to have a different diameter and the fitting holes 147, 149 are also formed to have a different diameter, so that the lid member 114 is prevented from being fitted to the plate 112 upside down.

At each of the four corners of the main body 116, an insertion hole 154 through which a bolt 152 is inserted is formed. Likewise, at each of the four corners of the plate 112 and of the lid member 114, insertion holes 156 and 158 are formed, respectively.

As shown in FIG. 7, in the second embodiment of the present invention, preferably the flow channel 128 is a microchannel-like minute flow channel having an equivalent diameter D of 1 mm (1000 μm) or less, preferably 500 μm or less. This is because the present invention, though it is applicable even to cases where the flow channel 128 has a large equivalent diameter and liquids flow in the turbulent-flow through the flow channel, is more effective where the equivalent diameter of the flow channel 128 is 1 mm or less and object liquids and a functional liquid flow laminarly through the flow channel. The diameter d of the plate penetration 112A, the flow channel width (space) W2 of the slit cylindrical penetration 112B and the equivalent diameter of the outer layer flow channel 115CW1 should be set appropriately according to the equivalent diameter of the flow channel 128 or the amount of the object liquids L1, L2 and of the functional liquid LK fed to the flow channel 128.

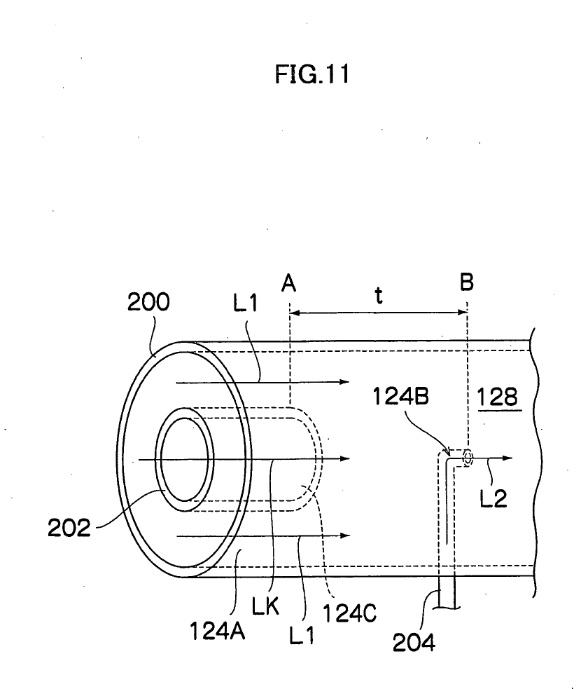

In FIG. 7, the outlets of the feeding channels 124A, 124B, 124C are the same, in other words, the feeding channels join the flow channel 128 at the same position 34. However, it is preferable that the position A where the object liquid L1 joins the functional liquid LK and the position B where the object liquid L2 join the liquids L1, LK are different, as shown in FIG. 11. Specifically, the feeding channels are formed to be a double-structured pipe by providing an outer cylindrical pipe 200 and an inner cylindrical pipe 202 in such a manner as to place the inner cylindrical pipe 202 in the inside of the outer cylindrical pipe 200 in the upstream portion of the same. And the object liquid L1 is allowed to flow through the feeding channel formed between the outer cylindrical pipe 200 and the inner cylindrical pipe 202 and the functional liquid LK is allowed to flow through the feeding channel in the inside of the inner cylindrical pipe 202. A piping 204 is provided so that a liquid can be discharged in the downstream position of the inner cylindrical pipe 202 in the axial direction toward the downstream, and the object liquid L2 is allowed to flow through the piping 204. Thus, a three-layer annular flow structure is formed which consists of the flows of the object liquid L1, the functional liquid LK and the object liquid L2 from the inside outward, and there is produced a time-lag between the joining of the object liquid L1 and the functional liquid LK at the position A and the joining of the object liquid L2 and the liquids L1, LK at the position B. The feeding channels for the object liquid L1 and that of the object liquid L2 are exchangeable.

Owing to such a step-by-step joining, a stable functional layer can be formed between the object liquids L1 and L2 while keeping the flows of the object liquids L1, L2 stable. In addition, the functions of the functional liquid LK can affect the object liquids L1, L2 highly accurately. The time-lag t between the joining of liquids L1 and LK at position A and the joining of liquids L2 and L1, LK at position B is preferably between 0.001 second and 60 seconds, more preferably between 0.001 second and 30 seconds and particularly preferably between 0.001 second and 10 seconds.

According to a production device 100 constructed as described above, an annular functional layer is formed between the annular object liquids L1 and L2, as objects of reaction operations or unit operations, by allowing the functional liquid LK having a function of controlling the reaction operations or unit operations to flow through the flow channel 128, whereby the functional liquid LK can directly affect the object liquids L1, L2. Thus, the reaction operations or unit operations for the object fluids L1, L2 in the flow channel 128 can be controlled highly accurately, and besides, the liquids L1, L2 can be provided with various functions according to the type of the reaction operations or unit operations for the object liquids L1, L2, whereby desired chemicals, which have never been produced, can be produced.

As shown in FIG. 11, if the object liquids L1, L2 and the functional liquid LK are allowed to join each other gradually, the flows of the object liquids L1, L2 and the functional liquid LK in the flow channel 128 are stabilized, whereby reaction operations or unit operations can be carried out highly accurately.

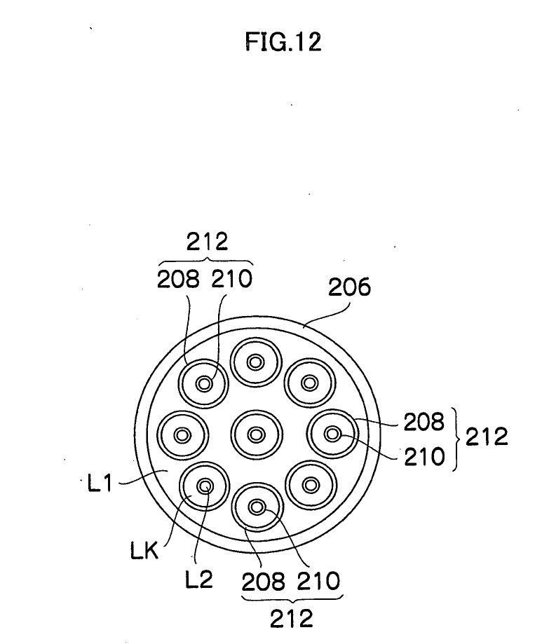

FIG. 12 shows a variation of the production device forming an annular flow, wherein a plurality of double-structured pipes 212 consisting of an outer cylindrical pipe 208 and an inner cylindrical pipe 210 is provided in the inside of a cylindrical outer shell pipe 206, and the fluids are allowed to join in a single flow channel 128 by allowing the object fluid L1 to flow through the flow channel formed between the cylindrical outer shell pipe 206 and the outer cylindrical pipe 208, the functional liquid LK to flow through the flow channel formed between the outer cylindrical pipe 208 and the inner cylindrical pipe 210, and the object liquid L2 to flow through the flow channel inside the inner cylindrical pipe 210. In this production device, a plurality of 2-layer flow structures consisting of the functional liquid LK and the object liquid L2 is formed, and the object liquid L1 is allowed to flow in such a manner as to wrap the outside of the plurality of two-layer flow structures. The feeding channel for the object liquid L1 and that for the liquid L2 are exchangeable.

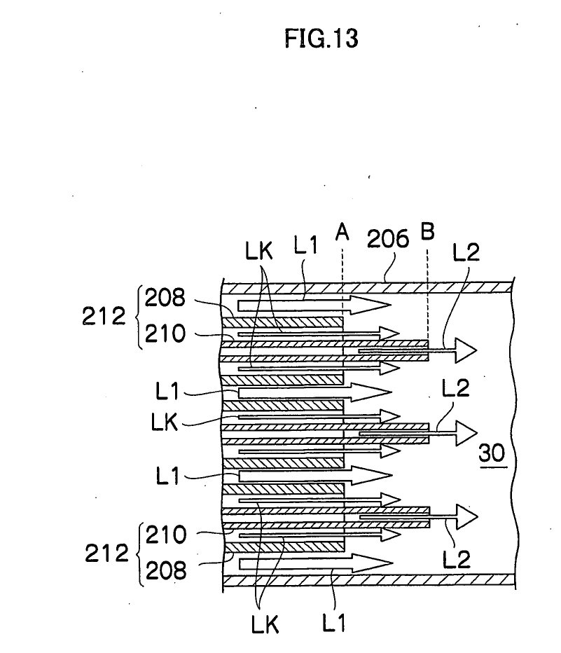

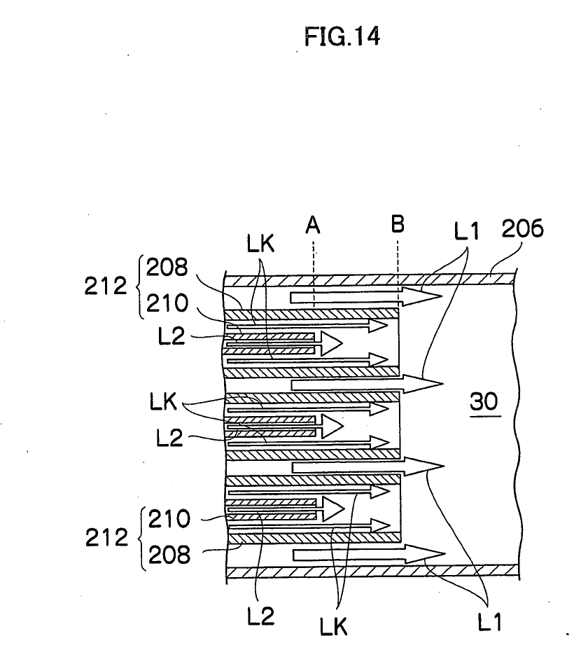

In this production device forming an annular flow, preferably the fluids joining position A and the fluids joining position B are different, as shown in FIG. 13 or 14. FIG. 13 shows a device of a type where first the object liquid L1 and the functional liquid LK join each other at the position A and then the object liquid L2 joins the two liquids L1 and LK at the position B. FIG. 14 shows a device of a type where first the object liquid L2 and the functional liquid LK join each other at the position A and then the object liquid L1 joins the two liquids L1 and LK at the position B.

In the second embodiment of the present invention, the functions of the functional liquid LK, and the micro machining technologies, materials and liquid feeding device 16 for feeding the object liquids and liquid feeding device 20 for feeding the functional liquid which are used for producing the production device are all the same as those described in first embodiment. The example of reaction operation (production of pigment particles) described in the first embodiment can also be carried out in the second embodiment. In the production device 100 forming an annular flow shown in FIGS. 4 to 10, only one discharge pipe is provided; however, it is a prerequisite that when such liquid membrane extraction is performed, separation is to be done at the outlet of the device; and thus, it is necessary to provide two discharge pipes.

One preferred example in which the method for producing chemicals of the present invention described so far is used is pigment production. Organic pigments of any hues, including magenta pigments, yellow pigments and cyan pigments, can be used in the present invention. Particularly, magenta pigments such as perylene, perynone, quinacridone, quinacridonequinone, anthraquinone, anthranthrone, benzimidazolone, disazo condensation, disazo, azo, indanthron, phthalocyanine, triarylcarbonium, dioxazine, aminoanthraquinone, diketopyrrolopyrrole, thioindigo, isoindoline, isoindolinone, pyranthrone, or isoviolanthrone pigments, or the mixtures thereof; yellow pigments; or cyan pigments can be used in the present invention.

More particularly, organic pigments used in the present invention include: for example, perylene pigments such as C.I. Pigment Red 190 (C.I. No. 71140), C.I. Pigment Red 224 (C.I. No. 71127) and C.I. Pigment Violet 29 (C.I. No. 71129); perynone pigments such as C.I. Pigment Orange 43 (C.I. No. 71105) and C.I. Pigment Red 194 (C.I. No. 71100); quinacridone pigments such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. Nos. 73900, 73906) and C.I. Pigment Red 209 (C.I. No. 73905); quinacridonequinone pigments such as C.I. Pigment Red 206 (C.I. No. 73900/73920), C.I. Pigment Orange 48 (C.I. No. 73900/73920) and C.I. Pigment Orange 49 (C.I. No. 73900/73920); anthraquinone pigments such as C.I. Pigment yellow 147 (C.I. No. 60645); anthranthrone such as C.I. Pigment Red 168 (C.I. No. 59300); benzimidazolone pigments such as C.I. Pigment Brown 25 (C.I. No. 12510), C.I. Pigment Violet 32 (C.I. No. 12517), C.I. Pigment Yellow 180 (C.I. No. 21290), C.I. Pigment yellow 181 (C.I. No. 11777), C.I. Pigment Orange 62 (C.I. No. 11775) and C.I. Pigment Red 185 (C.I. No. 12516); disazo condensation pigments such as C.I. Pigment Yellow 93 (C.I. No. 20710), C.I. Pigment yellow 94 (C.I. No. 20038), C.I. Pigment Yellow 95 (C.I. No. 20034), C.I. Pigment yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262 and C.I. Pigment Brown 23 (C.I. No. 20060); disazo pigments such as C.I. Pigment yellow 13 (C.I. No. 21100), C.I. Pigment Yellow 83 (C.I. No. 21108) and C.I. Pigment yellow 188 (C.I. No. 21094); azo pigments such as C.I. Pigment Red 187 (C.I. No. 12486), C.I. Pigment Red 170 (C.I. No. 12475), C.I. Pigment Yellow 74 (C.I. No. 11714), C.I. Pigment Red 48 (C.I. No. 15865), C.I. Pigment Red 53 (C.I. No. 15585), C.I. Pigment Orange 64 (C.I. No. 12760) and C.I. Pigment Red 247 (C.I. No. 15915); indanthron pigments such as C.I. Pigment Blue 60 (C.I. No. 69800); phthalocyanine pigments such as C.I. Pigment Green 7 (C.I. No. 74260), C.I. Pigment Green 36 (C.I. No. 74265), Pigment Green 37 (C.I. No. 74255), Pigment Blue 16 (C.I. No. 74100), C.I. Pigment Blue 75 (C.I. No. 74160:2) and 15 (C.I. No. 74160); triarylcarbonium such as triarylcarbonium pigments such as C.I. Pigment Blue 56 (C.I. No. 42800) and C.I. Pigment Blue 61 (C.I. No. 42765:1); dioxazine pigments such as C.I. Pigment Violet 23 (C.I. No. 51319) and C.I. Pigment Violet 37 (C.I. No. 51345); aminoanthraquinone pigments such as C.I. Pigment Red 177 (C.I. No. 65300); diketopyrrolopyrrole pigments such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71 and C.I. Pigment Orange 73; thioindigo pigments such as C.I. Pigment Red 88 (C.I. No. 73312); isoindoline pigments such as C.I. Pigment Yellow 139 (C.I. No. 56298) and C.I. Pigment Orange 66 (C.I. No. 48210); isoindolinone pigments such as C.I. Pigment Yellow 109 (C.I. No. 56284) and C.I. Pigment Orange 61 (C.I. No. 11295); pyranthrone pigments such as C.I. Pigment Orange 40 (C.I. No. 59700) and C.I. Pigment Red 216 (C.I. No. 59710); and isoviolanthrone pigments such as C.I. Pigment Violet 31 (C.I. No. 60010).

### Example

Pigment particles were produced using a production device 100 forming an annular flow as described in FIGS. 4 to 10. As a flow channel 128, a flow channel having an equivalent diameter of 1 mm or less was selected so that object liquids L1, L2 and a functional liquid LK flow laminarly through the flow channel 128.

The object liquid L1 was a solution of dimethyl sulfoxide (DMSO), PVP as a polymer, 0.8 mole of KOH as an alkaline agent, and Pigment Red as a pigment. The pigment concentration was 1.0% by weight.

The object liquid L2 was a solution of N-oleyl-N-methyltaurine sodium salt (manufacturer: Sankyo Chemical Co., Ltd.) as a surfactant and water. The surfactant concentration was 0.84% by weight.

The functional liquid LK was a solution of 0.8 mole of KOH as an alkaline agent and PVP as a polymer in dimethyl sulfoxide (DMSO).

These liquids L1, L2 and LK were fed to the production device 100, and a concentric 3-layer flow structure having a functional layer of the functional liquid LK between the object liquids L1, L2 (refer to FIG. 9) was formed in the flow channel 128. In the 3-layer structure, the central layer was made up of the object liquid L1, the outer layer the object liquid L2 and the intermediate layer the functional layer LK.

The changes in the particle size of the pigment particles produced by the reaction between the object liquids L1 and L2 with the flow rate of the functional liquid LK, which formed the intermediate layer, were examined while fixing the flow rate of the object liquid L1, which formed the central layer, at 1 mL/hour and the flow rate of the object liquid L2, which formed the outer layer, at 48 mL/hour. The flow rates of the functional liquid LK used in this test were: 1 mL/hour, 0.8 mL/hour, 0.6 mL/hour, 0.4 mL/hour, 0.2 mL/hour and 0.1 mL/hour. As a comparative example, the object liquids L1 and L2 were reacted with each other without the functional liquid LK.

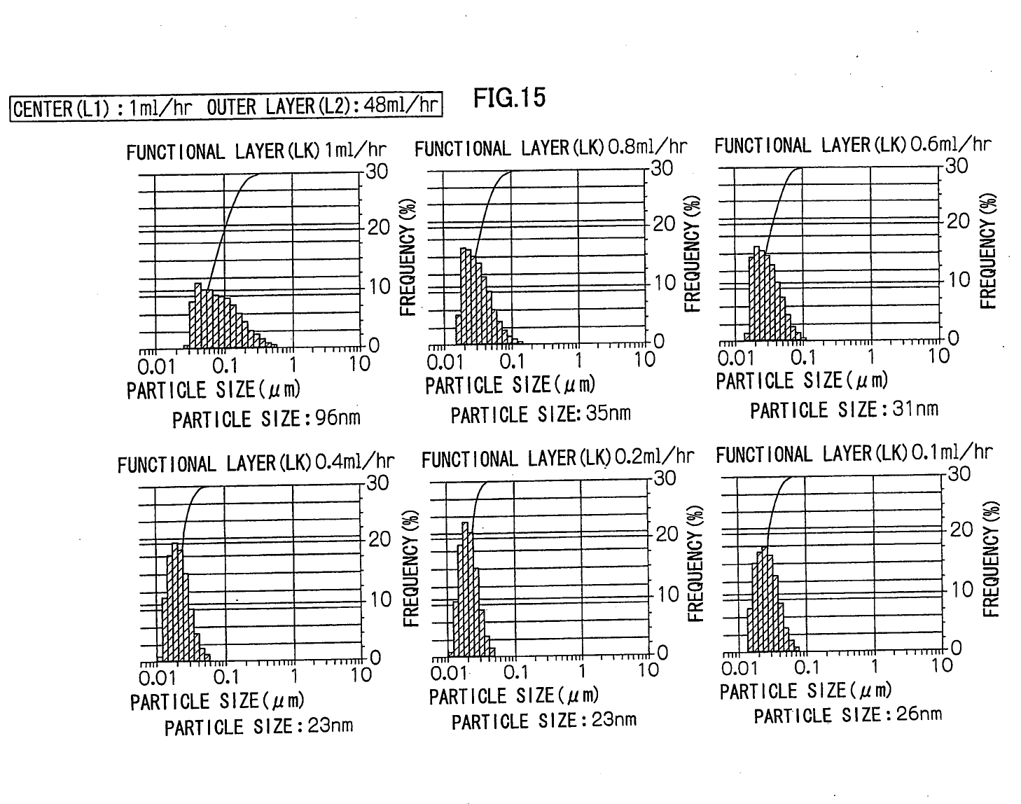

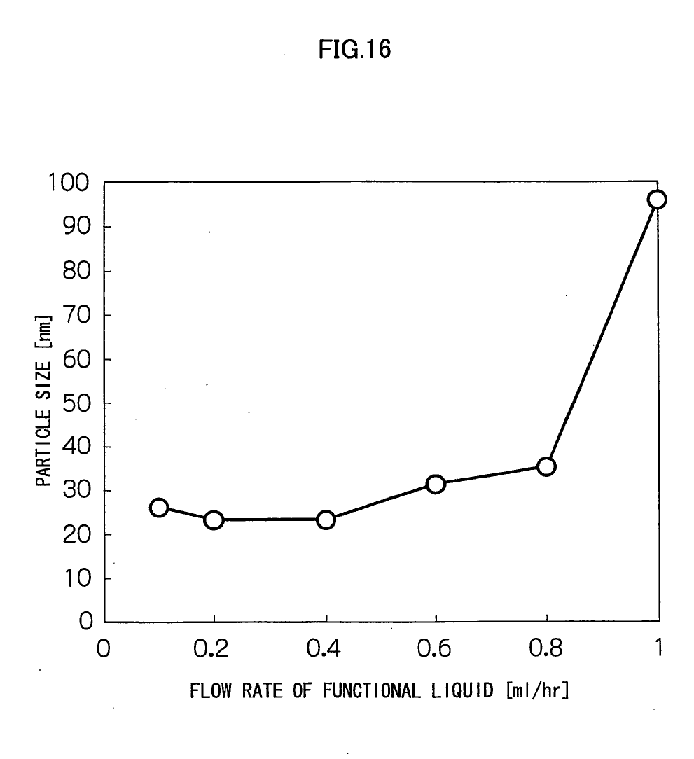

FIGS. 15 and 16 show the test results.

As is apparent from these figures, as the flow rate of the functional liquid LK decreases, the particle size of the pigment particles produced tends to decrease. Particularly when the flow rate of the functional liquid LK was decreased from 1 mL/hour to 0.8 mL/hour, the particle size was rapidly made fine, from 96 nm to 35 nm, and the particle-size distribution also decreased, as shown in FIG. 15; thus, excellently monodisperse pigment particles could be produced. When the flow rate of the functional liquid LK was decreased to 0.8 mL/hour or less, the particle size was gradually decreased; however, the rate was low. When the flow rate of the functional liquid LK was 0.6 mL/hour, the thickness of the functional layer was about 10 μm (calculated assuming that the linear velocity was constant right after the fluids joining).

On the other hand, in the comparative example where the object liquids L1 and L2 were reacted without the functional liquid LK, the pigment particles produced deposited at the joining portion, and their particle size was large and polydisperse. As is shown in FIGS. 15 and 16, when the flow rate of the functional liquid was decreased to 0.1 mL/hour, the particle size tended to increase a little. This indicates that if the thickness of the functional liquid LK is too thin, the functional layer is not formed, but deposition occurs. Accordingly, too thin a functional fluid is not preferable.

The results confirmed that to produce excellently monodisperse fine pigment particles, preferably the thickness of the functional layer is between 1 μm and 100 μm, more preferably between 1 μm and 50 μm and particularly preferably between 1 μm and 10 μm.

### INDUSTRIAL APPLICABILITY

As described so far, the method for producing chemicals of the present invention can be used, in devices which carry out reaction operations or unit operations for fluids flowing through their flow channels, for controlling the reaction operations or unit operations for the object fluids highly accurately, and besides, providing a functional fluid with various functions according to the type of the reaction operations or unit operations for the object fluids.

1-13. (canceled)

14. A method for producing chemicals using a device in which a plurality of object fluids are fed through respective fluid-feeding channels therefor and joined together in a single flow channel to carry out reaction operations or unit operations, the method comprising the step of:
forming a functional layer between the object fluids by allowing a functional fluid having a function of controlling the reaction operations or unit operations to flow through the flow channel.

15. A method for producing chemicals using a device in which three or more fluids are fed through respective fluid-feeding channels therefor and joined together in a single flow channel to carry out reaction operations or unit operations, the method comprising the step of:
providing, in the flow channel, a plurality of fluid-joining positions in which the three or more fluids are joined together gradually and allowing the three or more fluids to flow therethrough so that the time-lag between the fluid-joining at one joining position and the fluid-joining at the next joining position is between 0.001 second and 60 seconds.

16. The method for producing chemicals according to claim 15, the method including forming a functional layer of a functional fluid between object fluids,
wherein the three or more fluids consist of the object fluids carrying out the reaction operations or unit operations, and the functional fluid having a function of controlling the reaction operations or unit operations.

17. The method for producing chemicals according to claim 14, wherein the device is a microchemical device in which the flow channel has an equivalent diameter of 1 mm or less.

18. The method for producing chemicals according to claims 15, wherein the device is a microchemical device in which the flow channel has an equivalent diameter of 1 mm or less.

19. The method for producing chemicals according to claim 14, wherein the fluids flow laminarly in the flow channel.

20. The method for producing chemicals according to claim 15, wherein the fluids flow laminarly in the flow channel.

21. The method for producing chemicals according to claim 14, wherein the functional fluid in the reaction operations has a function of controlling the rate of the reaction between the object fluids.

22. The method for producing chemicals according to claim 21, wherein the rate of the reaction is controlled by allowing at least one of the temperature, viscosity, pH, concentration and density of the functional fluid to differ from the temperature, viscosity, pH, concentration or density of the object fluids.

23. The method for producing chemicals according to claim 14, wherein the functional fluid in the reaction operations has a function of controlling the particle size of the chemicals as products of the reaction between the object fluids.

24. The method for producing chemicals according to claim 14, wherein the functional fluid in the unit operations has a function of liquid membrane extraction.

25. The method for producing chemicals according to claim 14, wherein the plurality of object fluids are gradually joined together via the functional layer and with a time-lag between one fluid-joining step and the next fluid-joining step.

26. The method for producing chemicals according to claim 25, wherein the time-lag between one fluid-joining step joining and the next fluid joining step is between 0.001 second and 60 seconds.

27. The method for producing chemicals according to claim 14, wherein the function layer has a thickness of between 1 μm to 1000 μm.

28. The method for producing chemicals according to claim 14, wherein the chemicals are pigments.

29. The method for producing chemicals according to claim 15, wherein the chemicals are pigments.
